(19) United States
(12) Patent Application Publication
(10) Pub. No.: US 2026/0268129 A1
(43) Pub. Date: Sep. 10, 2026

(54) FRACTIONAL ORDER MEMCAPACITIVE NEUROMORPHIC SYSTEMS, NEURAL NETWORKS, AND ARTIFICIAL INTELLIGENCE PLATFORMS

(71) Applicant: Board of Regents, The University of Texas System, Austin, TX (US)

(72) Inventor: Fidel Santamaria, San Antonio, TX (US)

(21) Appl. No.: 19/561,437

(22) Filed: Mar. 9, 2026

Related U.S. Application Data
(60) Provisional application No. 63/768,771, filed on Mar. 7, 2025.

(51) Int. Cl. G06N 3/063; G06N 3/049

(52) U.S. Cl. CPC G06N 3/063; G06N 3/049

(57) ABSTRACT

Fractional-order memcapacitive neuromorphic systems, neural networks, and artificial intelligence platforms are disclosed. The systems incorporate a fractional-order memcapacitor that simultaneously exhibits fractional-order differentiation (0<η<1) and memcapacitive pinched-hysteresis behavior in the voltage-charge plane. This single analog element provides intrinsic non-local history-dependent memory, enabling power-law spike-timing adaptation, criticality with power-law avalanches, spectrum whitening of natural 1/f\hat{ }β signals, and direct reproduction/prediction of electrosensory pyramidal neuron activity in low-static-power hardware.

### RELATED APPLICATIONS

This application claims priority to U.S. Provisional Patent Application 63/768,771 filed Mar. 7, 2025 which is incorporated herein by reference in its entirety.

### STATEMENT REGARDING FEDERALLY FUNDED RESEARCH

This invention was made with government support under 1R01EB026939 awarded by the National Institute of Mental Health. The government has certain rights in the invention.

### FIELD

The present disclosure relates generally to the field of neuromorphic computing and, more particularly, to fractional-order memcapacitive neuromorphic systems, neural networks, and artificial intelligence platforms.

### BACKGROUND

Neuromorphic systems aim to replicate the structure and function of biological neural networks in hardware to achieve efficient, low-power computation for perception, learning, and decision-making tasks. Conventional neuromorphic circuits, such as those based on leaky integrate-and-fire (LIF) or Hodgkin-Huxley (HH) models, typically reset their internal state after each action potential and therefore lack intrinsic history dependence. As a result, they cannot natively reproduce the multiple-timescale, power-law adaptation of spike timing and firing rate that is observed across many brain regions and species. This limitation forces designers to rely on external digital memory or complex auxiliary circuitry, which increases power consumption and reduces the computational efficiency that neuromorphic hardware is intended to provide.

Electrical elements with memory (memelements) have been explored to address this gap. Memristors, the most widely studied memelement, can emulate synaptic weights but exhibit relatively high static power dissipation. Memcapacitors have been proposed as a lower-power alternative because they are static devices whose capacitance can vary with prior activity. However, prior memcapacitor implementations have not simultaneously provided the non-local, fractional-order differentiation required to model the history-dependent dynamics of real neurons. Fractional-order differential equations naturally capture the power-law memory effects seen in biological spike-timing adaptation, yet implementing a true fractional-order derivative in analog hardware has remained elusive due to the absence of circuit elements possessing both fractional differentiation (Caputo derivative of non-integer order η, 0<η<1) and memcapacitive pinched-hysteresis behavior.

A pressing need therefore exists for neuromorphic systems, neural networks, and artificial intelligence platforms that incorporate an intrinsic fractional-order memcapacitive element capable of delivering history-dependent spiking dynamics—including delayed onset, accelerating inter-spike intervals, spectrum whitening of natural 1/f\hat{ }β signals, criticality with power-law avalanche distributions, and long-term post-stimulus adaptation—without external memory or additional digital control. Such systems would enable energetically efficient hardware that not only emulates but can also predict the behavior of biological neurons, opening new avenues for scalable, brain-like computation.

Additionally there remains an unmet need for a neuromorphic system, a neural network, and an artificial intelligence system that intrinsically provides non-local history-dependent memory for spiking neuron emulation through the use of a fractional-order memcapacitor simultaneously exhibiting (i) fractional-order differentiation of non-integer order η where 0<η<1 and (ii) memcapacitive pinched-hysteresis behavior in the voltage-charge plane.

### SUMMARY

The present invention addresses the problems discussed above by utilizing a fractional-order memcapacitor that simultaneously exhibits (i) fractional-order differentiation of non-integer order η where 0<η<1 and (ii) memcapacitive pinched-hysteresis behavior in the voltage-charge plane to intrinsically provide non-local history-dependent memory directly within the analog core of spiking neuron circuits. The minimal traditional neural network is twice as big as certain embodiments. Furthermore, when using a fractional order of 0.5 the fractional network achieves much higher rates of learning, efficiency, and robustness than other networks.

In certain aspects, the invention provides a neuromorphic system comprising at least one fractional-order memcapacitor. In certain embodiments, the fractional-order memcapacitor comprises a plurality of super-capacitors electrically coupled in series, a CMOS-implemented fractional-order capacitor, or a biological material exhibiting fractional-order capacitance. Herein, the memcapacitor may have 0.6<η<0.95. In further embodiments, the neuromorphic system comprises a fractional-order leaky integrate-and-fire circuit in which the memcapacitor serves as the integrating element, or a fractional-order Hodgkin-Huxley-type circuit in which the memcapacitor is placed in a voltage-gated conductance branch, including the potassium n-gate. The system herein generates complex spikes containing plateau potentials, operates at criticality producing avalanches whose size distribution follows a power law, exhibits fractional-order differentiation of sinusoidal inputs with power-law gain and fixed phase advance, performs spectrum whitening of 1/f\hat{ }β input signals, and reproduces or predicts power-law spike-timing adaptation, criticality, fractional differentiation, and long-term post-stimulus history dependence observed in biological pyramidal neurons of the electrosensory lateral line lobe of weakly electric fish.

In certain aspects, the invention provides a neural network comprising a plurality of interconnected spiking neuron circuits, wherein at least one circuit includes the fractional-order memcapacitor, thereby imparting intrinsic history-dependent spiking dynamics to the network. In certain embodiments, the neural network incorporates the same realizations and configurations of the fractional-order memcapacitor described above, including super-capacitors, CMOS implementations, or biological materials, and exhibits the same performance properties of complex spikes, criticality with power-law avalanches, fractional differentiation, spectrum whitening, and biological correspondence.

In certain aspects, the invention provides an artificial intelligence system comprising at least one spiking neuron circuit that incorporates the fractional-order memcapacitor, whereby the system performs history-dependent computation using intrinsic memory. In certain embodiments, the artificial intelligence system utilizes the same realizations and configurations of the fractional-order memcapacitor and exhibits the same performance properties described above.

Herein, the fractional-order memcapacitor may be realized as a stack of super-capacitors, a CMOS fractional-order capacitor, or a biological material exhibiting fractional-order capacitance. The resulting hardware directly reproduces and predicts the spontaneous and evoked spiking activity of biological pyramidal neurons, including those recorded from the electrosensory lateral line lobe of Apteronotus leptorhynchus, thereby delivering both energetic efficiency and computational optimality for signals found in the natural world.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a composition and/or method that “comprises” a list of elements (e.g., components or features or steps) is not necessarily limited to only those elements (or components or features or steps) but may include other elements (or components or features or steps) not expressly listed or inherent to the composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

Definitions—The following definitions are provided to clarify the meaning of specific terms used throughout this patent application. These terms are defined to ensure a clear and consistent understanding of the scope, embodiments, and claims. Unless otherwise specified, the terms used herein have the meanings set forth below.

“Fractional-order memcapacitor” refers to a circuit element that simultaneously exhibits both (i) fractional-order differentiation of non-integer order η (where 0<η<1) and (ii) memcapacitive behavior characterized by pinched hysteresis in the voltage-charge plane. The element may provide intrinsic, non-local memory based on its prior electrical history.

“Fractional-order differentiation” refers to a mathematical operation using a non-integer order derivative (Caputo, Grunwald-Letnikov, or equivalent definition) of order η (0<η<1) that may incorporate memory of past states into the present response.

“Memcapacitive pinched-hysteresis behavior” refers to a property of a capacitive element in which the voltage-charge relationship traces a closed loop that is pinched at the origin and whose shape depends on the frequency or history of the applied signal.

“Non-local history-dependent memory” refers to the intrinsic ability of a circuit element or system to have its present output influenced by activity occurring over multiple prior time scales, without requiring separate external storage or reset mechanisms.

“Neuromorphic system” refers to any hardware or circuit architecture designed to emulate aspects of biological neural processing, including but not limited to spiking dynamics, adaptation, or computation.

“Neural network” refers to a collection of interconnected spiking neuron circuits that collectively process information in a distributed, parallel manner.

“Artificial intelligence system” refers to any computing platform that employs spiking neuron circuits to perform perception, learning, decision-making, pattern recognition, or other cognitive tasks.

“Spiking neuron circuit” refers to an analog or mixed-signal circuit that generates discrete output pulses (spikes or action potentials) in response to input signals, including but not limited to leaky integrate-and-fire or Hodgkin-Huxley-type topologies.

“Power-law adaptation” refers to a change in spike timing, firing rate, or response characteristics that follows a power-law relationship with time or prior activity.

“Criticality” refers to a dynamical regime in which a system produces events (such as avalanches of spikes) whose size or duration distribution follows a power law, indicating operation at the boundary between ordered and disordered states.

“Spectrum whitening” refers to the transformation of a 1/f\hat{ }β (pink-noise) input signal into an output whose power spectrum is substantially flatter than the input, indicative of optimal information coding.

These definitions are intended to be read in their broadest reasonable interpretation consistent with the specification and are not limited to any specific materials, circuit topologies, numerical values of f, or biological examples disclosed herein.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1A is a Voltage vs. Time Response of a super-capacitor stack to a 20 μA step current for a super-capacitor stack and fit to analytical solution.

FIG. 1B is a Voltage vs. Charge plot of a super-capacitor stack in response to a voltage saw-tooth input at different frequencies.

FIG. 2A is a schematic diagram of a fractional leaky integrate-and-fire (fLIF) circuit according to the teachings of the present disclosure.

FIGS. 2B-2E are various plots of the fLIF circuit in response to various inputs according to the teachings of the present disclosure.

FIGS. 3A-3D are various plots of the fLIF circuit showing history-dependence and fractional differentiation properties in response to various inputs according to the teachings of the present disclosure.

FIGS. 4A-4D are various plots of the fLIF circuit showing power spectrum whitening properties in response to various inputs according to the teachings of the present disclosure.

FIG. 5A is a circuit model schematic of the fLIF analog circuit according to the teachings of the present disclosure.

FIGS. 5B-5G are various plots of the fLIF circuit shown in FIG. 5A showing history-dependence and fractional differentiation properties according to the teachings of the present disclosure.

FIG. 6A is a circuit schematic diagram of the fractional order Hodgkin and Huxley (fHH) circuit according to the teachings of the present disclosure.

FIGS. 6B-6K are various plots of the fHH circuit showing history-dependence and fractional differentiation properties in response to various inputs according to the teachings of the present disclosure.

FIGS. 7A-7C are various plots of the fHH circuit in sub-critical state in response to various inputs according to the teachings of the present disclosure.

FIGS. 8A-8F are various plots of the fHH circuit showing optimal coding properties in response to various inputs according to the teachings of the present disclosure.

FIGS. 9A-9F are various plots of the fHH circuit in criticality showing history-dependence properties in response to various inputs according to the teachings of the present disclosure.

FIG. 10 is a simplified diagram illustrating an operating environment of a neuromorphic system constructed from fractional order memcapacitive neuromorphic elements according to the teachings of the present disclosure.

FIG. 11 is an example computing device upon which a neuromorphic system constructed of fractional order memcapacitive neuromorphic elements may operate according to the teachings of the present disclosure.

### DETAILED DESCRIPTION

The following discussion is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment and not intended to imply that the scope of the disclosure, including the claims, is limited to that embodiment.

According to the present invention, fractional-order memcapacitive neuromorphic systems, neural networks, and artificial intelligence platforms are provided that achieve intrinsic, non-local history-dependent spiking dynamics through the use of a single fractional-order memcapacitor. This element exhibits (i) fractional-order differentiation of non-integer order η (where 0<η<1) and (ii) memcapacitive pinched-hysteresis behavior in the voltage-charge plane. By embedding these properties directly into the analog core of spiking neuron circuits, the disclosed systems may generate power-law spike-timing adaptation, spectrum whitening of natural 1/f\hat{ }β signals, criticality with power-law avalanche distributions, complex spikes with plateau potentials, and long-term post-stimulus memory without external digital memory, reset mechanisms, or high-static-power components.

A neuromorphic system is a type of computing architecture designed to mimic the neural structure and functioning of the human brain. The term “neuromorphic” refers to the use of silicon-based circuits and systems to replicate the neuro-biological architectures present in the nervous system. This approach aims to achieve more efficient and powerful computing, particularly for tasks involving perception, learning, and decision-making. Neuromorphic systems are built using artificial neurons and synapses, which emulate the way biological neurons and synapses function in the brain. These artificial neurons and synapses are used to construct neural networks that can process information in parallel, much like the human brain. Components of a neuromorphic system include neurons, synapses, and memristors. Neurons (“artificial neurons” in the context of the invention) are the basic processing units that integrate input signals and generate output spikes based on the activation threshold. Synapses are the weighted connections between neurons. Memristors are specialized components used in some neuromorphic systems to emulate synaptic weights. Memristors have memory properties that allow them to retain information about past electrical states.

There is an increasing need to implement neuromorphic systems that are both energetically and computationally efficient. There is also great interest in using electric elements with memory, memelements, that can implement complex neuronal functions intrinsically. A feature not widely incorporated in neuromorphic systems is history-dependent action potential time adaptation which is widely seen in real cells. History-dependent action potential time adaptation refers to the phenomenon where the timing and characteristics of action potentials (the rapid rise and fall in voltage or membrane potential in a neuron) are influenced by the neuron's prior activity. This means that the behavior of action potentials is not solely a response to current stimuli but also depends on the history of previous stimuli the neuron has received. Previous theoretical work shows that power-law history dependent spike time adaptation, seen in several brain areas and species, can be modeled with fractional order differential equations. A fractional order differential equation is a type of differential equation that involves derivatives of non-integer (fractional) order. These equations generalize the concept of integer-order differentiation and integration to non-integer orders, providing a powerful tool for modeling complex systems with memory and hereditary properties. Fractional order differential equations provide a versatile and comprehensive framework for modeling complex systems with memory effects that cannot be adequately described by traditional integer-order differential equations. The present disclosure describes a leaky integrate and fire (LIF) circuit and a Hodgkin-Huxley (HH) circuit, both showing power-law spiking time adaptation and optimal coding properties.

The fractional order leaky integrate-and-fire (LIF) and Hodgkin-Huxley (HH) computer models (circuits) are capable of reproducing a wide range of results of power-law history dependent firing rate and spike timing adaptation. Since power-law history-dependence in neurons shows optimal coding properties, it is desirable to implement neuromorphic circuits with such non-linear self-adapting mechanism. However, implementing a fractional order derivative in an electric circuit has been elusive, primarily due to the lack of electric elements with such properties. The present disclosure describes the implementation of neuromorphic systems with memcapacitors with differentiation properties based on LIF and HH circuits built with super-capacitors. Super-capacitors, also known as ultracapacitors or electrochemical capacitors, are energy storage devices that bridge the gap between conventional capacitors and rechargeable batteries. They are characterized by their ability to store and release energy quickly, making them suitable for applications requiring rapid charge and discharge cycles. Super-capacitors store energy electrostatically through the formation of an electric double layer at the interface between the electrode material and the electrolyte.

The fractional order LIF model is:

$${D}^{η} v = {G}_{m} v + i ( t ) \qquad ( 1 )$$

where v is voltage, Gm is the membrane conductance, i is current, t is time, and Dη is the Caputo definition of a fractional order derivative of order η:

$${D}^{η} v = \frac{1}{Γ ( 1 - η )} {\int }_{0}^{t} \frac{{D}^{1} v ( t )}{{( t - u )}^{η}} du \qquad ( 2 )$$

The (t−u)−η term is the intrinsic memory trace. The voltage resets at threshold (vTh) and has a refractory period (tr). The memory trace continuously integrates past activity.

The classic LIF is a model of current through a resistor and an ideal capacitor in parallel (i.e., Equation 1 with η=1). The current, ic, through the capacitor with capacitance Co is:

$${i}_{c} ( t ) = {C}_{o} {D}^{1} v ( t ) \qquad ( 3 )$$

By analogy, in the fractional LIF model this corresponds to a fractional order capacitor:

$${i}_{c} ( t ) = {C}_{o} {D}^{η} v ( t ) \qquad ( 4 )$$

Real capacitors have an associated conductance Gc:

$${i}_{c} ( t ) = {v}_{C} ( t ) {G}_{c} + {C}_{o} {D}^{η} {v}_{c} ( t ) \qquad ( 5 )$$

Using a Laplace transform on both sides, re-arranging and applying an inverse Laplace transform the response of this circuit to a constant input current, ic(t)=I, is:

$${v}_{C} ( t ) = {v}_{c} ( {t}_{0} ) + I / {G}_{c} ( 1 - {E}_{η} ( - t / {τ}_{C} ) ) \qquad ( 6 )$$

With τC=Co/Gc, and Eη(z) the Mittag-Leffler function. At asymptotic times, this equation converges to a power-law:

$${v}_{C} ( t ) = {v}_{C} ( {t}_{0} ) + I ( 1 / {G}_{c} + {t}^{η} / {C}_{o} Γ ( 1 + η ) ) \qquad ( 7 )$$

When η=1 and Rc=1/Gc=0 the equation reduces to the ideal capacitor represented by the following equation:

$$I = {C}_{o} \frac{{v}_{C} ( t ) - {v}_{C} ( {t}_{0} )}{t} \qquad ( 8 )$$

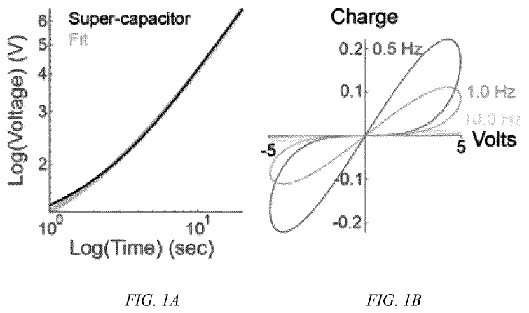

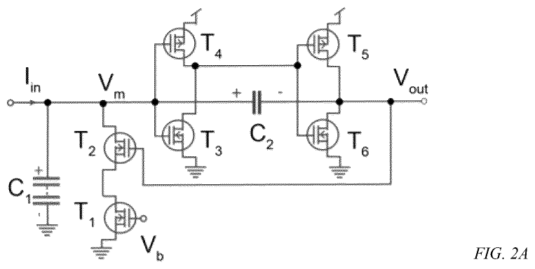

The charging and discharging properties of some super-capacitors follow fractional order dynamics. Super-capacitors have capacitances orders of magnitude larger than traditional electrolytic capacitors because these elements are mainly designed for energy storage applications. Four 22 mF super-capacitors are connected in series to reduce their capacitance to an equivalent capacitance of 5.5 mF. Using Equation 7, it is determined that the super-capacitor stack has a fractional derivative order, η=0.82±2.20×10-3 95% CI. As shown in the plot in FIG. 1A, a super-capacitor has fractional order and memcapacitive properties. FIG. 1A shows the voltage vs. time response to a 20 μA step current for a super-capacitor stack (black) and fit to analytical solution (gray).

A memcapacitor is defined as:

$$q = C ( x , v , t ) v and {D}^{1} x = f ( x , v , t ) \qquad ( 9 )$$

where q is electric charge; C is capacitance with units of F/x·t; and x is an internal variable (such as the flux, φ). From the definition of flux:

$${D}^{1} φ = v \qquad ( 10 )$$

If it is assumed that C(φ, v, t)=C0φ, then:

$$q = {C}_{0} {\int }_{0}^{t} vd τ \cdot v \qquad ( 11 )$$

Equation 11 results in a hysteresis curve pinched at the origin. As shown in FIG. 1B, the measured voltage vs. charge plot of the super-capacitors in response to a voltage saw-tooth input at different frequencies shows hysteresis pinched at the origin and a frequency dependent amplitude, both properties of memcapacitors. Thus, the super-capacitors have fractional order derivative and memcapacitive properties.

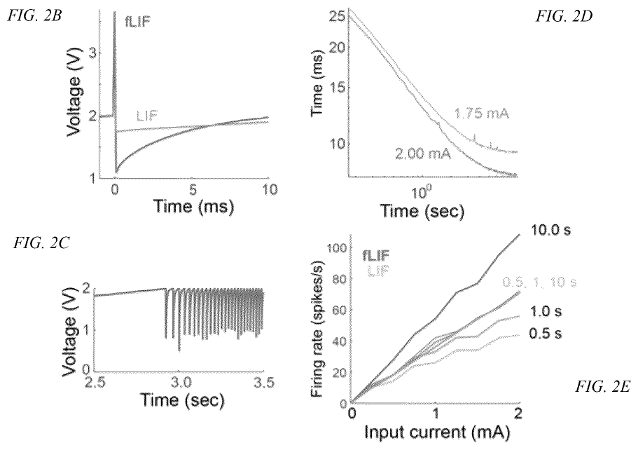

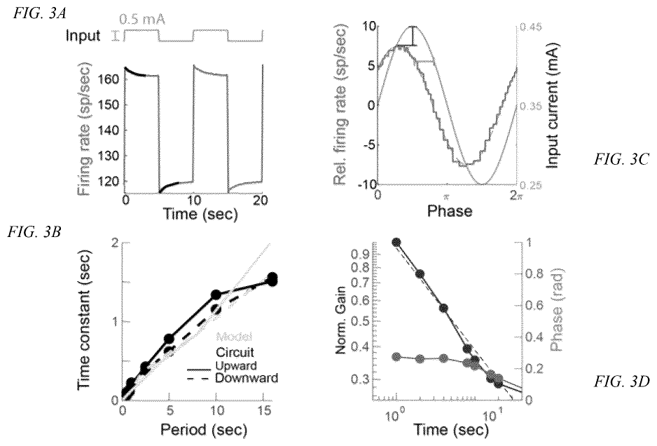

FIG. 2 is a circuit diagram of a LIF neuron implemented with analog electrical components. This analog circuit generates spikes of less than 0.1 ms with vth=2 V and C1=0.1 μF. When using an electrolytic 5 mF capacitor, the LIF circuit failed to generate action potentials (0.1-10 mA input), not shown. However, the circuit with the super-capacitor stack generated spikes with the same vth but with higher amplitude (FIG. 2B). This is because the charging of super-capacitors is much slower than electrolytic capacitors thus allowing the circuit to function. The classic LIF circuit generates action potentials at a constant rate when stimulated with constant current. By contrast, the fractional LIF (fLIF) circuit shows a delay in generating the first spike, followed by a power-law decrease in the inter-spike intervals (ISIs, FIGS. 2C and 2D). An example of a spike train generated in response to a 2 mA constant input is shown in FIG. 2C. FIG. 2D shows an inter-spike interval as a function of time and constant input current. The combination of slowed onset in firing and acceleration of the ISI affects the calculation of the firing rate from the time of onset of the first spike (FIG. 2E). However, at longer stimulation times, the firing rate of the fractional LIF circuit becomes faster than for the classical case. This is a process in which the intrinsic memory trace acts as a feedback mechanism that feeds into increasing firing rates.

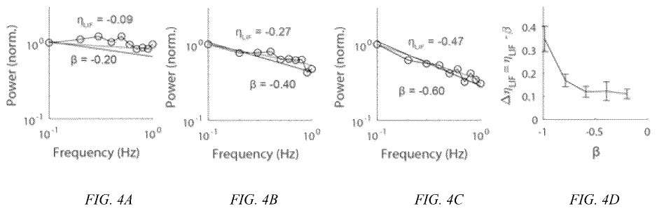

A square-wave of different frequencies is provided as input into the fractional LIF circuit (FIG. 3A). The DC and amplitude of the input signal were adjusted to always generate action potentials. The time constant of instantaneous firing rate adaptation for the positive and negative parts of the cycle is calculated as a function of period length by fitting a single exponential to each phase of the cycle (FIG. 3A black). This resulted in a time constant of adaptation that depended on the previous period length, which is a non-linear phenomenon observed in real neurons (FIG. 3B black). The fractional LIF model reproduced this behavior (η=0.2, FIG. 3B gray). Thus, the firing rate of the fractional LIF shows history dependence.

To determine if the fractional order properties of the super-capacitors were reflected in the firing rate activity of the neuron, if the firing rate, f, of a neuron encodes the input, In=A sin(2πωt), as a fractional order derivative, then:

$$f = \frac{{d}^{η} {I}_{n}}{d {t}^{η}} \to f = {A ( 2 π ω )}^{η} sin ( 2 πω t + \frac{η π}{2} ) \qquad ( 12 )$$

A sinusoidal input signal is injected into the fractional LIF neuronal circuit. The amplitude and DC components are set to generate spikes at all input values. The input wavelength (λ=1/ω) is varied from 0.1 s to 40 s and fitted a sine function to the instantaneous firing rate (FIG. 3C). This shows that the firing rate amplitude decays as a power-law, ηG=0.39±0.07, and the phase shift is fixed ηφ=0.32±0.04 SEM (Standard Error of the Mean) (FIG. 3D). Thus, the fractional LIF circuit has fractional order derivative properties.

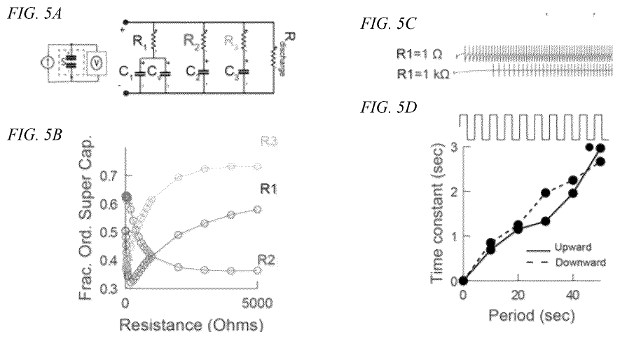

The power-spectrum of multiple natural signals have a power-law structure (1/fβ) also known as pink-noise. From Equation 12, if β=η and A=(2πω)−β then the power spectrum of the firing rate should be flat, ηLIF~0, also known as spectrum whitening, which is a tale-tale of optimal coding computations. The same additive properties predict a constant shift in the exponent of the firing rate power spectrum, ΔηLIF=ηLIF−β. ΔηLIF calculated to inputs with pink-noise (range 0.01 to 1.00 Hz) and varying β values. (FIG. 4A-4D). This analysis shows that for β=[−0.2, −0.4, −0.6] the value ΔηLIF is constant. For values of β<−0.6 the system becomes less sensitive to the input. The same analysis shows that the firing rate spectrum is flat when β=−0.2 (ηLIF=−0.09±0.14 95% CI (confidence interval).

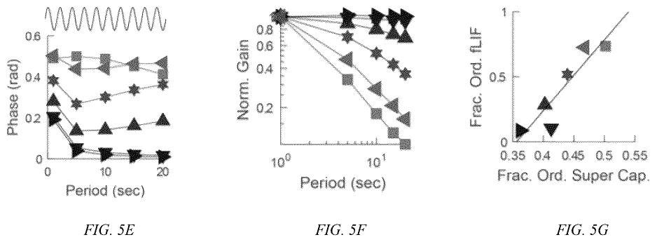

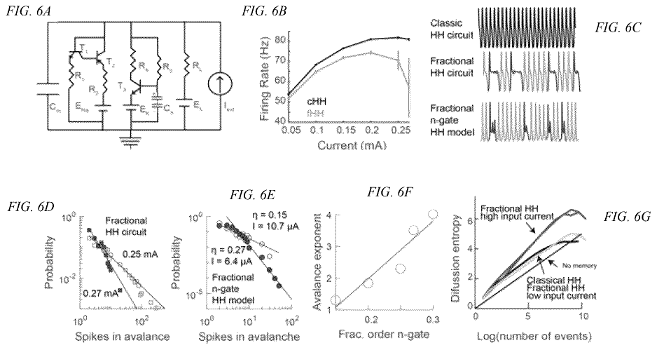

An analogue circuit simulation platform is used to study the effect of fractional order super-capacitors of different orders on the responses of the fractional LIF circuit. A super-capacitor circuit model shown in FIG. 5A is used for this simulation. The values of the resistances in the model were varied systematically and the resulting fractional order was characterized and shown in FIG. 5B. FIG. 5C shows examples of spike responses of the fractional LIF circuit model to constant input. FIG. 5D shows time constant of adaptation of the fractional LIF model in response to square wave inputs of different periods. FIGS. 5E and 5F show the firing rate phase and gain in response to sinusoidal current input of different periods and as a function of the order of the fractional order of the super-capacitor. FIG. 5G shows the relationship between the fractional orders of the spiking response calculated from E and the fractional order of the super-capacitor.

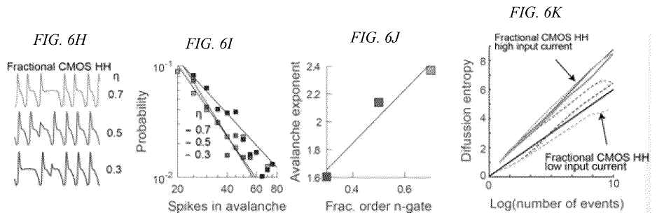

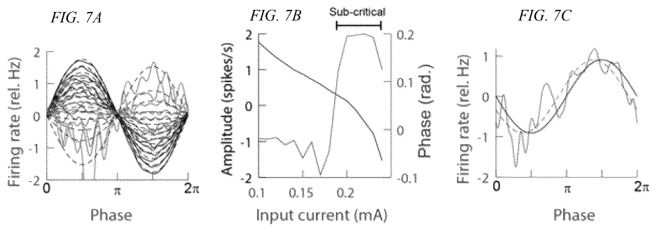

FIG. 6A shows a circuit diagram of the classic Hodgkin and Huxley (cHH) circuit that incorporates a stack of super-capacitors, Cn. More specifically, a stack of five super-capacitors (47 mF each) connected in series with fractional order of η2=0.93±0.01 95% CI is added to the n-gate part of the circuit. The fHH and cHH circuits have the same vth. FIG. 6B is a plot of firing rate vs. input current for the classical (cHH; black) compared with the fHH (blue) circuits. At high currents (>0.25 mA) the fractional HH circuit showed increased variability and reduction in firing rate. This was because the circuit generated a mixture of normal and complex spikes, spikes containing a plateau potential of varying periods that lasted for as long as the stimulus was on. FIG. 6C provides examples of spike trains of the cHH and fHH circuits (0.27 mA in both), and the fractional n-gate HH computer model (10.7 μA and η=0.15). The fractional HH computer model replicated the complex spikes using η=0.2-0.3 for the n-gate. A phase plane plot of the measured and modeled complex spikes shows mixed mode oscillations with a smaller attractor representing the plateau known as a canard. Thus, the complex spikes emerge from the internal dynamics of the system and not from some saturation in the circuit.

The apparent random nature of the complex spikes was because the circuit was at criticality. An avalanche is defined as the number of simple spikes between two complex spikes. The histogram of avalanches follows a power-law, consistent with a system in criticality. FIG. 6D shows a histogram of avalanches in the fHH circuit for two input currents. This was also replicated in the model with the fractional order of the nn-gate linearly related to the avalanche structure. FIG. 6E shows histograms generated by the fractional order computer model. FIG. 6F shows avalanche exponent vs. value of η of the n-gate in the fHH computer model. Thus, complex spikes emerge when the system is at criticality.

Diffusion entropy analysis characterizes stochastic processes with memory. This analysis shows that both the classical and fractional HH circuits at low-input current have no memory. By contrast, the fHH circuit at criticality shows history-dependence FIG. 6G shows a diffusion entropy analysis of the fHH circuit under different input current states. The difference in dynamics in the fractional HH circuit is probably due that at low input current the dynamics are controlled by electrolytic capacitor and at higher input current (and voltages) the super-capacitors dominate the dynamics.

Instead of super-capacitors a CMOS implementation of fractional order capacitors was used. For the three different values of fractional order implemented in the chip the HH circuit generated avalanches and the spiking activity showed diffusion entropy history-dependence. FIG. 6H shows spike trains when using a CMOS implementation of a fractional order capacitor with the HH circuit, I=0.3 mA. FIG. 6I shows avalanche histograms generated by the CMOS fHH circuit. FIG. 6J shows avalanche exponent as a function of the fractional order of the CMOS capacitor from FIG. 6I. FIG. 6K shows a diffusion entropy analysis of the CMOS fHH circuit.

Fractional order capacitance is also found in skin, fruits, and vegetables, due to their fractal cellular structures. To generalize the results, the circuit is implemented using dried fruit, η=0.67±0.03 95% CI. Under such arrangement the HH circuit generated complex spikes and power-law ISIs. Thus, collectively, the results show that fractional order capacitance, independent of its physical nature, is sufficient to generate fractional order spiking activity.

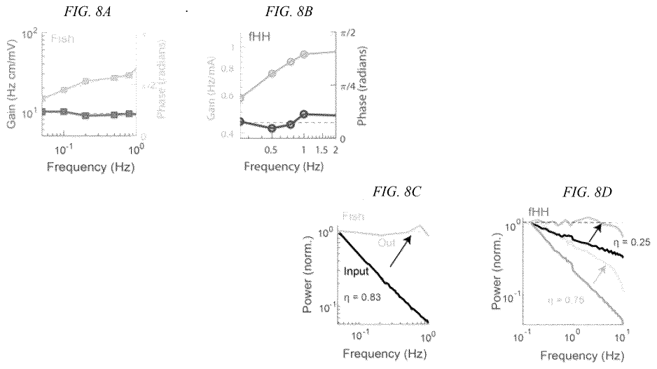

FIG. 7A shows the relative firing rate of the circuit in response to a 1 Hz sinusoidal input with a fixed amplitude AC=0.05 mA and varying DC (firing rate: solid red lines; fit: dashed red lines; input: solid black lines). The amplitude of the firing rate decreases and flips signs as DC values increase while the phase switches from negative to positive, as shown in FIGS. 7B and 7C. The flipping of the firing rate amplitude is because of widening of the spikes without becoming complex spikes (<0.22 mA). In the presence of complex spikes, there was no phase lag. The regime where there is positive phase in the absence of complex spikes is the sub-critical phase. The reversal in amplitude can be interpreted as a change in coding the input from the firing rate to the ISI (Equation 12). FIG. 7B shows the amplitude (gain) and phase shift with respect to input signal from A. FIG. 7C shows phase advance in the sub-critical regime (DC=0.26 mA and 0.05 mA amplitude at 1 Hz). The phase advance results in a fractional order derivative of η=0.23±0.01 95% CI.

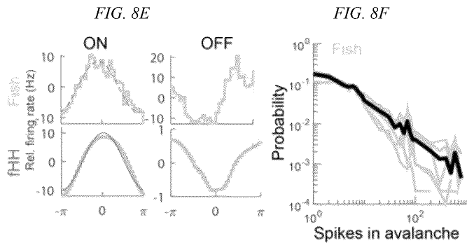

FIG. 8A shows the firing rate gain and phase shift of ELL (electro-sensory line lobe) neurons in the weakly electric fish in response to sinusoidal stimulation. It has been shown that neurons in weakly-electric fish perform a fractional differentiation of modulated electrical stimulation with a gain characterized by ηELLg=0.26±0.09 95% CI, and phase advance of ηELLφ=0.43±0.02 SEM mediated by a potassium conductance. This behavior is replicated using the fractional HH circuit in the sub-critical state with an input current with DC of 2.4 μA and amplitude of 0.05 mA over a range of 0.25 to 2.00 Hz (FIG. 8B). The power-law gain, ηHHφ=0.33±0.08 95% CI, and the phase advance ηHHφ=0.26±0.03 SEM had values very close to those measured experimentally.

The same neurons that perform a fractional order differentiation show spectrum whitening of pink-noise signals. When some LS neurons from the ELL are stimulated with pink-noise with βIn=−0.83 the power-spectrum of the firing rate is flat, ηELLout=0.02±4×10-3 95% CI (FIG. 8C). The fractional HH circuit is stimulated with pink-noise with β=[−0.2, −2]. When a pink-noise with β=−0.2 was used, the exponent of the firing rate was flat, ηHHout=−0.07±0.21 95% CI. The power-spectrum to pink-noise with β=−0.75 was calculated, expecting a power-spectrum of ηHHout=−0.55, but the experimental results were close to ηHHout=−0.41±0.07 95% CI (FIG. 8D).

Without changing any parameters in the fractional HH circuit, reproduction of other properties of ELL neurons is tested. For example, neurons that show fractional order differentiation can be classified as ON or OFF cells. The ON cells follow the input, while OFF cells decrease their firing when the input is high. The fractional HH circuit at low input current (DC=1.0 mA, amplitude 0.05 mA) reproduces the ON behavior and without fractional order differentiation. In the sub-critical regime (DC=2.4 mA, amplitude 0.05 mA), the fHH circuit shows fractional differentiation and OFF behavior (FIG. 8E). At rest, the neurons of the ELL generate spiking bursts. This is hypothesized that the bursts are equivalent to the complex spikes observed in the fHH circuit. Indeed, the avalanches, number of spikes between bursts, in the weakly-electric fish have a power-law distribution with an exponent of −0.92±0.06 95% CI (FIG. 8F).

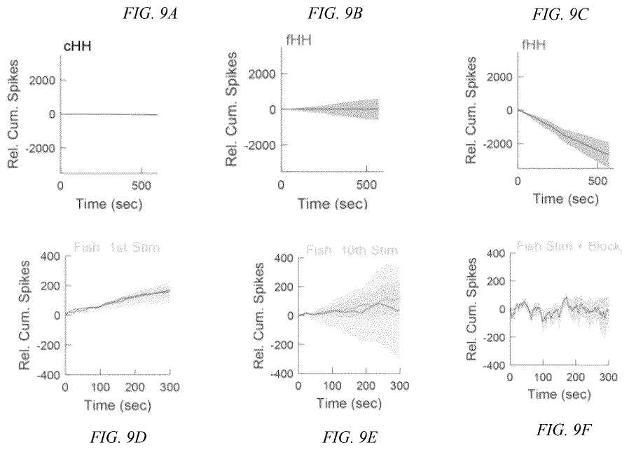

History-dependence should result in inputs affecting the spiking of the neuron for periods of time longer than its characteristic time constants. Using the circuit in normal, sub-critical, or critical regimes, in response to a stimulus (lower the input current for 30 sec but high enough to keep firing), spiking was observed and monitored for 10 minutes. The relative cumulative spikes between the post- and pre-stimulus times are calculated. The classical (FIG. 9A) and fractional sub-critical (not shown) circuits showed no changes in spiking activity (horizontal lines). FIG. 9B shows the control in the absence of a stimulus in the fHH circuit in criticality. The shaded areas correspond to 95% CI. By contrast, with a 30 second stimulus the circuit showed a prolonged and robust decrease in firing (FIG. 9C).

While recording from the live fish, a masking electric stimulus that inhibit ELL cells similar to the ‘low’ input current in the HH circuit was used. The cumulative spikes in the control and stimulus conditions are shown in FIG. 9D. This shows that ELL neurons respond to the masking stimulus with a robust increase in the cumulative spikes. The neurons continue to respond to subsequent stimulus over multiple repetitions. After the 8th period, the neurons show no change in cumulative spiking with respect to control (FIG. 9E).

Past work shows that fractional order optimal coding properties of ELL pyramidal neuron cells are strongly influenced by both feedback input from nucleus praeminentialis (nP) as well as serotonergic input. Feedback signals were bilaterally blocked and the experiment was repeated that showed no change in cumulative firing (FIG. 9F). Taken together, the results show that primary sensory neurons show long lasting intrinsic memory that is consistent with their fractional order properties.

The fractional-order memcapacitor disclosed herein provides a concrete technological improvement to analog neuromorphic computing systems by intrinsically embedding non-local, multi-timescale history-dependent memory directly within a passive, low-static-power circuit element. Unlike conventional leaky integrate-and-fire or Hodgkin-Huxley circuits that rely on digital memory resets or auxiliary high-power components (such as memristors with significant static dissipation), the present fractional-order memcapacitor enables analog-native implementation of power-law adaptation, criticality with power-law avalanche distributions, and spectrum whitening of natural 1/f\hat{ }β signals without external digital control or memory. This results in measurable reductions in power consumption, enhanced computational efficiency for processing biologically realistic signals, and improved fidelity in emulating or predicting multi-timescale neuronal dynamics observed in biological systems, such as pyramidal neurons in the electrosensory lateral line lobe of weakly electric fish. These improvements arise from the specific structural and material properties of the fractional-order memcapacitor (e.g., series-connected super-capacitor stacks, CMOS fractional-order capacitors, or biological dielectrics exhibiting simultaneous fractional differentiation and pinched-hysteresis behavior), which solve the technical problem of achieving intrinsic, non-volatile memory in analog spiking circuits while maintaining energetic efficiency and avoiding the latency and power overhead of hybrid digital-analog approaches.

Prior neuromorphic hardware has been limited by the absence of circuit elements capable of providing fractional-order differentiation (Caputo derivative, 0<η<1) combined with memcapacitive behavior in a single analog component, forcing reliance on external digital storage or complex auxiliary circuitry that increases power dissipation, reduces scalability, and compromises the intrinsic low-power advantage of neuromorphic design. The present invention addresses this technological problem through a particular hardware configuration: integration of the fractional-order memcapacitor as the integrating element in fractional-order leaky integrate-and-fire circuits or within voltage-gated conductance branches (e.g., the potassium n-gate) in fractional-order Hodgkin-Huxley-type circuits. This specific arrangement yields practical advantages including generation of complex spikes with plateau potentials, operation at criticality with power-law-distributed avalanches, fixed phase advance and power-law gain in response to sinusoidal inputs, and long-term post-stimulus adaptation exceeding 10 minutes—all demonstrated in physical hardware implementations (e.g., super-capacitor stacks with measured η≈0.82-0.93, CMOS fractional capacitors, and biological materials). These outcomes represent improvements to the functioning of analog neuromorphic processors and other analog circuit technologies by enabling energetically efficient, brain-like computation optimized for natural-world signals characterized by 1/f\hat{ }β power spectra.

In various embodiments, the fractional-order memcapacitor is physically realized as a discrete analog circuit component (such as a series stack of commercial super-capacitors, a fabricated CMOS fractional-order capacitor, or a biological dielectric material configured within the circuit), which integrates the recited fractional-order differentiation and memcapacitive pinched-hysteresis behavior into the analog core of the spiking neuron circuit. This hardware-specific integration provides a particular way of achieving history-dependent spiking dynamics and optimal coding properties that cannot practicably be performed by generic computing elements or mental processes, thereby improving the performance and efficiency of neuromorphic hardware systems over prior approaches that require digital resets or high-static-power memelements.

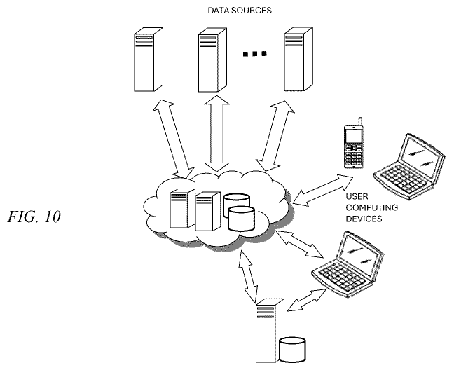

FIG. 10 is a simplified illustration of an example operating environment for a neuromorphic system constructed of fractional order memcapacitive neuromorphic elements according to the teachings of the present disclosure. The neuromorphic system may reside in a server in the cloud or in a user computing device. The origin of data processed by the neuromorphic system may be a variety of sources received via any number of suitable interfaces, including application programming interfaces (API).

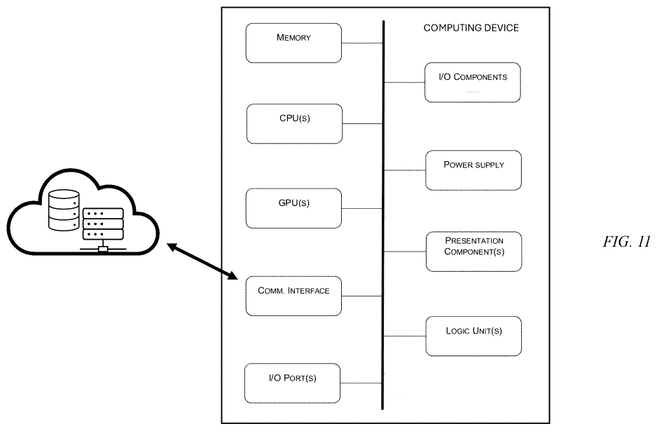

FIG. 11 is a simplified block diagram of an example computing device suitable for use in implementing some embodiments of the neuromorphic system and method described in the present disclosure. The neuromorphic system and method may be executed in the computing device or in one or more servers that reside in the cloud remote from the user(s). The computing device may include an interconnect system that directly or indirectly couples the following devices: memory, one or more central processing units (CPUs), one or more graphics processing units (GPUs), a communication interface, I/O ports, input/output components (e.g., touch screens, buttons, knobs), a power supply, one or more presentation components (e.g., display(s)), and one or more logic units. The computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” “augmented reality system,” and/or other device or system types, as all are contemplated within the scope of the computing device of FIG. 11.

The interconnect system may represent one or more links or busses, such as an address bus, a data bus, a control bus, or a combination thereof. Alternatively, the interconnect system may be a wireless communication system. The memory may include any of a variety of computer-readable media. The computer-readable media may be any available media that may be accessed by the computing device. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computing device.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) may be configured to execute the computer-readable instructions to control one or more components of the computing device to perform one or more of the methods and/or processes described herein. In addition to or alternatively from the CPU(s), the GPU(s) may be configured to execute at least some of the computer-readable instructions to control one or more components of the computing device to perform one or more of the methods and/or processes described herein. In addition to or alternatively from the CPU(s) and/or the GPU(s), the logic unit(s) may be configured to execute at least some of the computer-readable instructions to control one or more components of the computing device to perform one or more of the methods and/or processes described herein. In embodiments, the CPU(s), the GPU(s), and/or the logic unit(s) may discretely or jointly perform any combination of the methods, processes and/or portions thereof. One or more of the logic units may be part of and/or integrated in one or more of the CPU(s) and/or the GPU(s) and/or one or more of the logic units may be discrete components or otherwise external to the CPU(s) and/or the GPU(s).

The communication interface may include one or more receivers, transmitters, and/or transceivers that enable the computing device to communicate with other computing devices via an electronic communication network, including wired and/or wireless communications. The computing device may communicate and transmit data to and from cloud-based servers and databases. The applications employing the methodology described in the present disclosure may be embodied in software code residing and executing in the computing device and/or in cloud-based servers and databases. The communication interface may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports may enable the computing device to be logically coupled to other devices including the I/O components, the presentation component(s), and/or other components. Illustrative I/O components include microphone, mouse, keyboard, joystick, game pad, game controller, satellite dish, scanner, printer, wireless device, etc. The I/O components may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device. The computing device or the I/O components may include depth cameras, such as stereoscopic camera systems, infrared camera systems, RGB camera systems, touchscreen technology, and combinations of these, for gesture detection and recognition.

The presentation component(s) may include a display (e.g., a monitor, a touch screen, a television screen, a heads-up-display (HUD), other display types, or a combination thereof), speakers, and/or other presentation components. The presentation component(s) may receive data from other components (e.g., the GPU(s), the CPU(s), etc.), and output the data (e.g., as an image, video, sound, etc.).

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

### EXAMPLES

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1—Fractional-Order Leaky Integrate-And-Fire (FLIF) Neuromorphic System

A neuromorphic system according to claim 1 was constructed using the classic analog LIF topology (Mead design) in which the integrating capacitor was replaced by a fractional-order memcapacitor consisting of four 22 mF NEC/TOKIN #FS0H223ZF super-capacitors connected in series (equivalent capacitance≈5.5 mF, measured fractional order η=0.82±0.0022, 95% CI). The circuit was built with p-channel and n-channel MOSFETs, V_th=2 V, and generated spikes of <0.1 ms duration. Measurements were performed using a National Instruments PCI-6071E DAQ card and LabVIEW for current injection and voltage acquisition.

The fractional-order LIF model is given by:

$${D}^{η} v = {G}_{m} v + i ( t )$$

Where v is voltage, Gm is the membrane conductance, i is current, t is time, and Dn is the Caputo definition of a fractional-order derivative of order n:

$${D}^{η} v = \frac{1}{Γ ( 1 - η )} {\int }_{0}^{t} \frac{{D}^{1} v ( t )}{{( t - u )}^{η}} d u$$

(with Caputo derivative). When stimulated with constant current (0.1-10 mA), the system exhibited delayed first-spike onset followed by power-law shortening of inter-spike intervals (FIGS. 2C-2E). Square-wave inputs produced history-dependent adaptation whose time constant varied with prior stimulation period (FIG. 3B). Sinusoidal inputs (wavelength 0.1-40 s) were encoded according to:

$$f ( i ) \approx A sin ( 2 πω t + ϕ )$$

yielding power-law gain (η_G=0.39±0.07) and fixed phase advance (η_φ=0.32±0.04 SEM) (FIGS. 3C-3D). Pink-noise inputs (β=−0.2) produced spectrum whitening (flat firing-rate spectrum, η_LIF=−0.09±0.14, 95% CI) (FIGS. 4A-4D). All behaviors arose solely from the intrinsic memory of the fractional-order memcapacitor.

### Example 2—Fractional-Order Hodgkin-Huxley (FHH) Neuromorphic System

A neuromorphic system was constructed by modifying the Maeda-Makino pulse-type HH hardware neuron. Five 47 mF NEC/TOKIN #FYH0H473ZF super-capacitors were connected in series (η=0.93±0.01, 95% CI) and placed in the potassium n-gate branch. The circuit was driven with the same DAQ setup as Example 1.

The fractional-order gating dynamics for the n-gate follow:

$${D}^{η} v = \frac{1}{Γ ( 1 - η )} {\int }_{0}^{t} \frac{{D}^{1} v ( u )}{{( t - u )}^{η}} d u$$

where x is the gating variable (n for the potassium gate) and αx(V), βx(V) are the standard voltage-dependent rate functions of the Hodgkin-Huxley model.

At high input currents (>0.25 mA) the system operated at criticality, producing complex spikes with plateau potentials and power-law avalanche distributions (FIGS. 6B-6F), where avalanche size is defined as the number of simple spikes between two complex spikes. Diffusion entropy analysis confirmed intrinsic history dependence only in the critical regime (FIG. 6G). In the sub-critical regime, the system reproduced fractional differentiation (gain η=0.33±0.08, phase advance η=0.26±0.03 SEM) and spectrum whitening of pink-noise inputs, matching experimental recordings from ELL pyramidal neurons (FIGS. 8A-8D). Long-term post-stimulus adaptation lasting >10 minutes was observed and experimentally confirmed in live Apteronotus leptorhynchus (FIGS. 9A-9F).

### Example 3—Neural Network Embodiment

Multiple fLIF or fHH circuits of Examples 1 and 2 were interconnected to form a neural network. Each circuit contained its own fractional-order memcapacitor (super-capacitor stack or equivalent). The network was stimulated with shared or independent inputs via the DAQ system. The fractional-order memcapacitors provided distributed intrinsic memory across the network, enabling population-level power-law adaptation, criticality with power-law avalanches, and spectrum whitening without external memory or digital control. Interconnections were made through resistive or capacitive synapses as in standard neuromorphic topologies.

### Example 4—Artificial Intelligence System Embodiment

An artificial intelligence system was implemented by embedding one or more fLIF or fHH circuits (Examples 1 and 2) into a computing platform (FIG. 11). The fractional-order memcapacitors were integrated as hardware accelerators on the same board or via USB/PCIe interface to the CPU/GPU system. The system performed history-dependent perception and decision-making tasks on natural 1/f\hat{ }β signals (e.g., sensory or environmental data streams). Input currents were scaled to the circuit's operating range (0.1-10 mA) and output spikes were digitized for downstream processing. The resulting platform achieved energetic efficiency superior to memristor-based equivalents because the fractional-order memcapacitors consume negligible static power.

### Example 5—Alternative Fractional-Order Memcapacitor Implementations

The systems of Examples 1-4 were also constructed using (a) a CMOS fractional-order capacitor (Tsirimokou design, three different η values) and (b) a biological fractional-order capacitor (dried fruit slice, η=0.67±0.03, 95% CI). In each case the same circuit topologies and measurement procedures of Examples 1 and 2 were followed. Both substitutions produced identical spiking dynamics, power-law avalanches, diffusion-entropy history dependence, and biological correspondence (FIGS. 6H-6K), demonstrating that any element satisfying the definition of fractional-order memcapacitor may be used to practice the claimed invention.

### REFERENCES

Xiao et al., Biophysical Journal, 2015
Santamaria et al., Neuron, 2006
Marinov and Santamaria, BMC Neuroscience, 2013
Santamaria et al., European Journal of Neuroscience, 2011
Lundstrom et al., Nature Neuroscience, 2008
Anastasio, Biological Cybernetics, 1994
Huang and Chacron, The Journal of Neuroscience, 2016
Holland, MIT Press, 1992
Bakirov et al., Machine Learning, 2021
Tang et al., Advanced Materials, 2019
Boybat et al., Nature Communications, 2018
Li et al., Nature Communications, 2018
de Lemos and Grześ (eds.), IEEE, 2019
Couceiro et al., Signal, Image and Video Processing, 2012
Gheibi et al., ACM Transactions on Autonomous and Adaptive Systems, 2021
Cao et al., Neural Processing Letters, 2012
Santamaria et al., PLOS Computational Biology, 2010
Weinberg and Santamaria, Computational Models of Brain and Behavior, 2017
Vázquez-Guerrero et al., Chaos, Solitons & Fractals, 2019
Teka et al., PLOS Computational Biology, 2016
Teka et al., PLOS Computational Biology, 2014
Gilboa et al., Journal of Neuroscience, 2005
Tarasov, Communications in Nonlinear Science and Numerical Simulation, 2018
Elwakil, IEEE Circuits and Systems Magazine, 2010
Di Ventra et al., Proceedings of the IEEE, 2009
Chua and Kang, Proceedings of the IEEE, 1976
Li et al., Journal of Physics D: Applied Physics, 2018
Upadhyay et al., Advanced Materials Technologies, 2019
Jeong and Shi, Journal of Physics D: Applied Physics, 2018
Yin et al., IEEE Transactions on Circuits and Systems II: Express Briefs, 2015
Demasius et al., Nature Electronics, 2021
Abbasi et al., Nanotechnology, 2022
Wang et al., Nature Communications, 2018
Han et al., Advanced Intelligent Systems, 2022
Abdelouahab et al., International Journal of Bifurcation and Chaos, 2014
Raza et al., Nano Energy, 2018
Mead, Addison-Wesley, 1989
Miller et al., The Journal of Neuroscience, 2008
Gutmaniene et al., Brain Research, 2003
Beierlein et al., Journal of Neurophysiology, 2003
Tsirimokou et al., IEEE Transactions on Circuits and Systems II: Express Briefs, 2017
Dayan and Abbott, MIT Press, 2005
Allagui et al., Scientific Reports, 2016
Allagui et al., Journal of Power Sources, 2018
Şahin et al., Energies, 2022
Teka et al., PLOS Computational Biology, 2014
Lundstrom et al., Nature Neuroscience, 2008
Podlubny, Elsevier, 1998
Pozzorini et al., Nature Neuroscience, 2013
Huang et al., Nature Communications, 2016
Huang and Chacron, The Journal of Neuroscience, 2016
Metzen and Chacron, Journal of Experimental Biology, 2014
Atick and Redlich, Neural Computation, 1992
Stamper et al., Journal of Experimental Biology, 2012
Sproule et al., Neuroscience Letters, 2015
Lewicki, Nature Neuroscience, 2002
Rodríguez et al., The Journal of Neuroscience, 2010
Dan et al., The Journal of Neuroscience, 1996
Wang et al., Journal of Neurophysiology, 2003
Rieke et al., MIT Press, 1999
Atick, Network: Computation in Neural Systems, 2011
Weddell et al., IEEE Transactions on Circuits and Systems II: Express Briefs, 2011
Zubieta and Bonert, IEEE Transactions on Industry Applications, 2000
Villalba-Galea, Channels, 2017
Maeda and Makino, BioSystems, 2000
Wechselberger et al., Nonautonomous Dynamical Systems in the Life Sciences, 2013
Jalics et al., Dynamical Systems, 2010
O'Byrne and Jerbi, Trends in Neurosciences, 2022
Allegrini et al., Physical Review E, 2002
Jelinek et al., Frontiers in Physiology, 2021
Bohara et al., Physical Review E, 2017
Alimisis et al., Technologies, 2020
Roy et al., AIMS Biophysics, 2020
Mohsen et al., IEEE Access, 2021
Ávila-Åkerberg et al., Neuroscience, 2010
Berman and Maler, Journal of Experimental Biology, 1999
Coronel-Escamilla et al., Fractional-Order Modeling of Dynamic Systems, 2022
Serra-Peralta et al., Scientific Reports, 2022
Levitin et al., Proceedings of the National Academy of Sciences, 2012
Pinto et al., Communications in Nonlinear Science and Numerical Simulation, 2012
Brown et al., Philosophical Transactions of the Royal Society B, 2002
Machado et al., Signal Processing, 2015
Dong and Atick, Network: Computation in Neural Systems, 1995
Kinouchi et al., New Journal of Physics, 2008
Sharma et al., Journal of Energy Storage, 2019
González et al., Renewable and Sustainable Energy Reviews, 2016
TOKIN, SuperCapacitor User's Manual, 2017
Chatterjee and Nandi, Journal of Materials Chemistry A, 2021
Wang et al., Small Methods, 2019
Sung et al., Journal of Power Sources, 2006
Ahmadi et al., IET Circuits, Devices & Systems, 2012
Najem et al., Nature Communications, 2019
Basham et al., Smart Materials, Adaptive Structures and Intelligent Systems, 2019
Tran and Teuscher, Journal of Emerging Technologies in Computing Systems, 2021
Tran and Teuscher, IEEE/ACM International Symposium on Nanoscale Architectures, 2017
Tran and Teuscher, arXiv preprint, 2017
Rajagopal et al., Nonlinear Dynamics, 2018
Ma et al., Nonlinear Dynamics, 2020
Fitch et al., IEEE International Symposium on Circuits and Systems, 2014
Doi and Lewicki, PLOS Computational Biology, 2014
Gjorgjieva et al., PLOS Computational Biology, 2019
Liang et al., Advanced Intelligent Systems, 2021
Verdecchia et al., Wiley Interdisciplinary Reviews: Data Mining and Knowledge Discovery, 2023
Coronel-Escamilla et al., Chaos, Solitons & Fractals, 2020
Hitschfeld et al., ILAR Journal, 2009
Huang et al., eLife, 2018
Metzen et al., PLoS Biology, 2018
Bastian et al., The Journal of Neuroscience, 2002
Marsat et al., Journal of Neurophysiology, 2009
Mejias et al., PLoS Computational Biology, 2013
Stamper et al., Journal of Experimental Biology, 2013
Metzen and Chacron, Journal of Experimental Biology, 2014
Metzen and Chacron, Springer Handbook of Auditory Research, 2019
Bastian et al., Neuron, 2004
Huang and Chacron, The Journal of Neuroscience, 2016
Huang et al., Nature Communications, 2016
Haggard and Chacron, PLoS Computational Biology, 2023
Marquez and Chacron, Heliyon, 2023
Metzen and Chacron, iScience, 2023
Wang and Chacron, Scientific Reports, 2021
Maler et al., Journal of Chemical Neuroanatomy, 1991
Steinmetz et al., Science, 2021
Metzen and Chacron, The Journal of Neuroscience, 2021
Clarke and Maler, Current Biology, 2017

1. A neuromorphic circuit comprising at least one spiking neuron circuit that includes a fractional-order memcapacitor exhibiting both:
(i) a fractional-order differentiation of non-integer order η where 0<η<1, and
(ii) memcapacitive pinched-hysteresis behavior in the voltage-charge plane.

2. The neuromorphic circuit of claim 1, wherein the fractional-order memcapacitor comprises a plurality of super-capacitors electrically coupled in series.

3. The neuromorphic circuit of claim 1, wherein the fractional-order memcapacitor comprises a CMOS-implemented fractional-order capacitor.

4. The neuromorphic circuit of claim 1, wherein the fractional-order memcapacitor comprises a biological material configured as a dielectric exhibiting fractional-order capacitance within the circuit.

5. The neuromorphic circuit of claim 1, wherein the non-integer order η is 0.6<η<0.95.

6. The neuromorphic circuit of claim 1, configured as a fractional-order leaky integrate-and-fire circuit in which the fractional-order memcapacitor serves as an integrating element.

7. The neuromorphic circuit of claim 1, configured as a fractional-order Hodgkin-Huxley-type circuit in which the fractional-order memcapacitor is connected in a voltage-gated conductance branch.

8. The neuromorphic circuit of claim 7, wherein the fractional-order memcapacitor is located in the potassium n-gate.

9. The neuromorphic circuit of claim 1 that generates complex spikes containing plateau potentials.

10. The neuromorphic circuit of claim 1 that produces avalanches whose size distribution follows a power law, whereby the system operates at criticality.

11. The neuromorphic circuit of claim 1, configured to reproduce or substantially match at least one of power-law spike-timing adaptation, criticality, fractional differentiation, or long-term post-stimulus history dependence of pyramidal neurons recorded from the electrosensory lateral line lobe of Apteronotus leptorhynchus.

12. The neuromorphic circuit of claim 1 that performs spectrum whitening of 1/f\hat{ }β input signals in the firing-rate power spectrum.

13. The neuromorphic circuit of claim 1 that reproduces or predicts at least one of power-law spike-timing adaptation, criticality with power-law avalanches, fractional differentiation, or long-term post-stimulus history dependence observed in biological pyramidal neurons of the electrosensory lateral line lobe (ELL) of weakly electric fish.

14. The neuromorphic circuit of claim 1, wherein the fractional-order memcapacitor is formed by stacking four or five commercial super-capacitors selected from the group consisting of NEC/TOKIN FS0H223ZF (22 mF) and FYH0H473ZF (47 mF).

15. A neural network comprising a plurality of interconnected spiking neuron circuits, wherein at least one of the spiking neuron circuits is a neuromorphic circuit according to claim 1.

16. An artificial intelligence platform comprising at least one neuromorphic circuit according to claim 1 embodied as a hardware accelerator configured to perform history-dependent computation on signals exhibiting 1/f\hat{ }β power spectra.
